(19) United States
(12) Patent Application Publication
(10) Pub. No.: US 2009/0226793 A1
(43) Pub. Date: Sep. 10, 2009

(54) Fuel cell stack assembly

(75) Inventors: Jung Do Suh, Seoul (KR); Dai Gil Lee, Daejeon (KR)

Correspondence Address: EDWARDS ANGELL PALMER & DODGE LLP, P.O. BOX 55874, BOSTON, MA, 02205, US

(73) Assignees: Hyundai Motor Company, Seoul (KR); Korea Advanced Institute of Science and Technology, Daejeon (KR)

(21) Appl. No.: 12/218,113

(22) Filed: Jul. 11, 2008

(30) Foreign Application Priority Data
Dec. 13, 2007 (KR) 10-2007-0129544

(51) Int. Cl. H01M 2/02

(52) U.S. Cl. 429/34

(57) ABSTRACT

A fuel cell stack assembly includes a wire for assembling a fuel cell stack, which can maintain a constant surface pressure on the fuel cell by utilizing a wide elasticity range of the wire and ensure a high fastening force even with a small amount of material, thus making the fuel cell lightweight and maximizing the package efficiency. For this purpose, the present invention provides a fuel cell stack assembly including: at least one wire for fastening end plates mounted on both end portions of a fuel cell stack; at least one tensioner mounted on at least one portion of the top surface of an upper end plate; at least one tension guide each of which includes a central guide for guiding up and down movement of the tensioner and surrounds the tensioner; at least one upper guide mounted on both sides of the top surface of the upper end plate for guiding the wire; and at least one lower guide mounted on both sides of the bottom surface of a lower end plate for guiding the wire.

### CROSS-REFERENCE TO RELATED APPLICATION

This application claims under 35 U.S.C. §119(a) the benefit of Korean Patent Application No. 10-2007-0129544 filed Dec. 13, 2007, the entire contents of which are incorporated herein by reference.

### BACKGROUND

(a) Technical Field

The present invention relates to a fuel cell stack assembly, in which a wire is used to assemble a fuel cell stack while maintaining a constant surface pressure on each fuel cell by utilizing a wide elasticity range of the wire, which can ensure a high fastening force even with a small amount of material, thus making the fuel cell lightweight and maximizing the package efficiency.

(b) Background Art

In general, a fuel cell stack refers to an electrical energy generating device, in which a plurality of unit cells are piled up.

Such a fuel cell stack has a structure in which one to two hundred separators, gas diffusion layers (GDLs), gaskets, and the like are stacked in orderly manner, and end plates are attached to both ends of the fuel cell stack.

In a prior art fuel cell stack, the end plates on both ends of the fuel cell stack are typically coupled by means of bands or full thread bolts.

The prior art fuel cell stack, however, has drawbacks. For instance, since the gasket is often made from a rubber material having visco-elastic property that varies depending on ambient temperature of the stack, initial tightening force may be weakened as time goes by and may eventually fail to maintain the tightening force uniformly. In order to complement the incomplete tightening force on the gasket, the end plates on both ends of the stack are required to be further secured by means of an additional bolts or bands.

Hereinafter, the drawbacks of the prior art fuel cell stack assembly will be described in detail with reference to FIGS. A1 and 1B.

FIG. 1A is a schematic view of a conventional fuel cell stack in which end plates 20 are assembled by means of bolts 10, and FIG. 1B is a schematic view of a conventional fuel cell stack in which end plates 20 are assembled by means of bands 30.

The fuel cell stack as shown in FIG. 1A has drawbacks in that since the overall volume of a stack 50 is increased, it is difficult to package the stack 50. Moreover, the weight of the stack 50 is increased due to the weight of the bolts 10, and stress is concentrated on a thread portion of the bolt 10 when a load acts in the longitudinal direction of the bolt 10, and thus the thread portion may be easily damaged.

The fuel cell stack as shown in FIG. 1B has drawbacks in that it is difficult to control the surface pressure with respect to a stack 60, and it is also difficult to control the initial surface pressure since the size of the bands 30 is not uniform.

The information disclosed in the Background section is only for enhancement of understanding of the background of the invention and should not be taken as an acknowledgement or any form of suggestion that this information forms the prior art that is already known to a person skilled in the art.

### SUMMARY OF THE DISCLOSURE

The present invention has been made in an effort to solve the above-described problems associated with prior art. The present invention is directed to a fuel cell stack assembly which can maintain a constant surface pressure on the fuel cell by utilizing a wide elasticity range of the wire, and ensure a high fastening force even with a small amount of material, thus making the fuel cell lightweight and maximizing the package efficiency.

In one aspect, the present invention provides a fuel cell stack assembly for a fuel cell, the fuel cell stack assembly comprising: at least one wire for fastening end plates mounted on both end portions of a fuel cell stack; at least one tensioner mounted on at least one portion of the top surface of an upper end plate; at least one tension guide each of which includes a central guide for guiding up and down movement of the tensioner and surrounds the tensioner; at least one upper guide mounted on both sides of the top surface of the upper end plate for guiding the wire; and at least one lower guide mounted on both sides of the bottom surface of a lower end plate for guiding the wire.

Preferably, the tensioner may be mounted on the top surface of the upper end plate by means of a tension bolt such that the height of the tensioner can be adjusted by the tension bolt, thereby the tension of the wire being able to be adjusted.

Suitably, each of the tensioner, the upper guide and the lower guide may include a plurality of guide grooves such that the wires received in the guide grooves do not interfere with each other.

Also suitably, the lower guide may include a locking groove formed therein in a direction perpendicular to the guide grooves of the lower guide. Both ends of the wire are connected to a locking member mounted thereon. The locking member can be inserted into the locking groove of the lower guide.

Preferably, the wire is formed of, e.g., a piano wire or a shape memory alloy.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like.

The above features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other features of the present invention will now be described in detail with reference to certain exemplary embodiments thereof illustrated the accompanying drawings which are given hereinafter by way of illustration only, and thus are not limitative of the present invention, and wherein:

FIG. 1A is a schematic view of a conventional fuel cell stack assembled by means of bolts;

FIG. 1B is a schematic view of a conventional fuel cell stack assembled by means of bands;

FIG. 2 is a schematic top view of a fuel cell stack assembly in accordance with a preferred embodiment of the present invention;

FIG. 3 is a schematic bottom view of the fuel cell stack assembly of FIG. 2; and

FIGS. 4 to 6 are detailed views of the fuel cell stack assembly of FIG. 2.

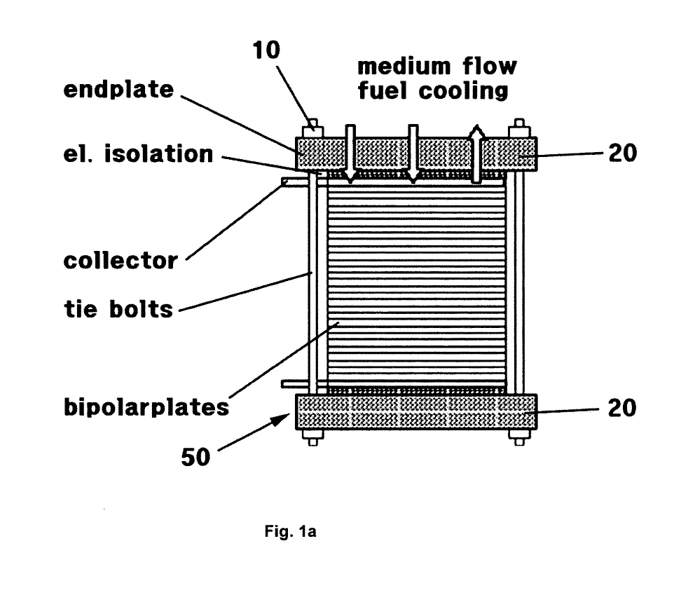

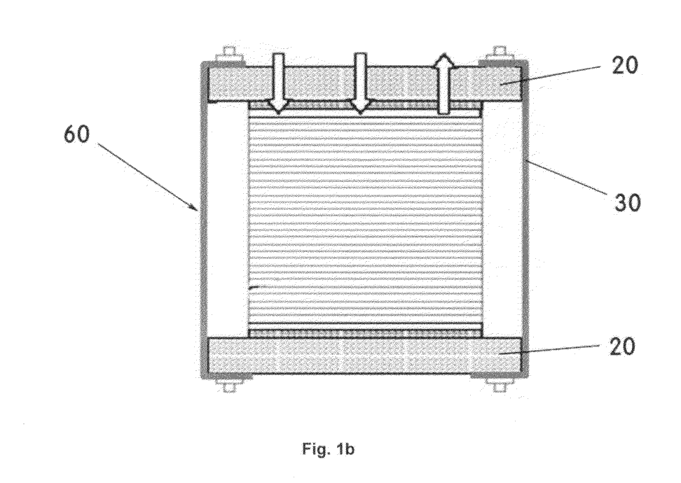

Reference numerals set forth in the Drawings includes reference to the following elements as further discussed below:

100: upper end plate
110: tensioner
120: tension guide
130: upper guide
140: lower end plate
150: lower guide
160: locking member
200: wire

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to the preferred embodiments of the present invention, examples of which are illustrated in the drawings attached hereinafter, wherein like reference numerals refer to like elements throughout. The embodiments are described below so as to explain the present invention by referring to the figures.

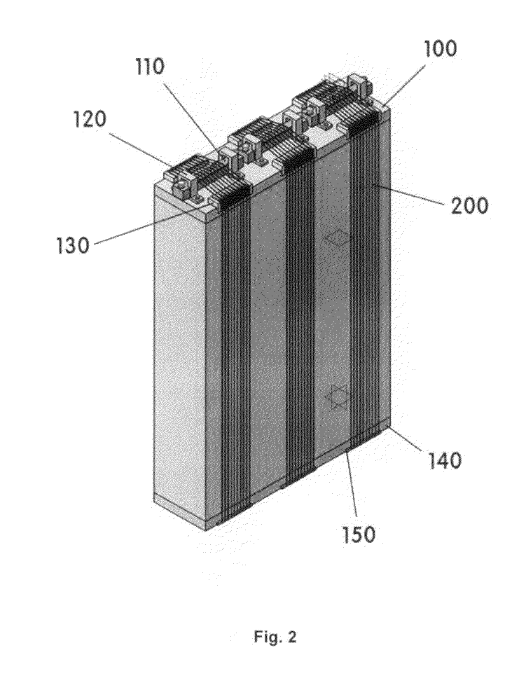

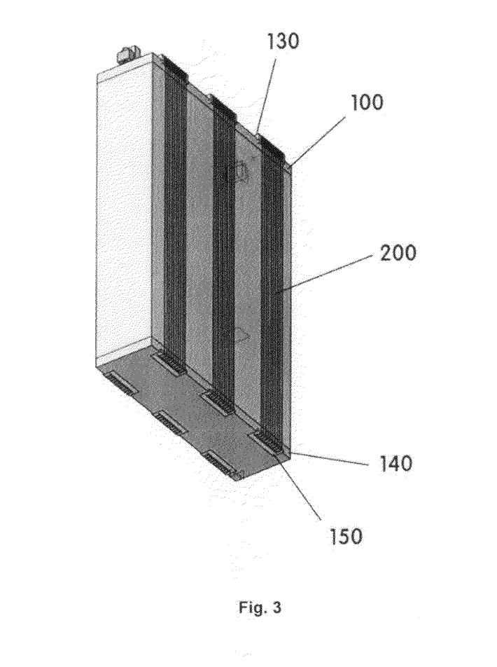

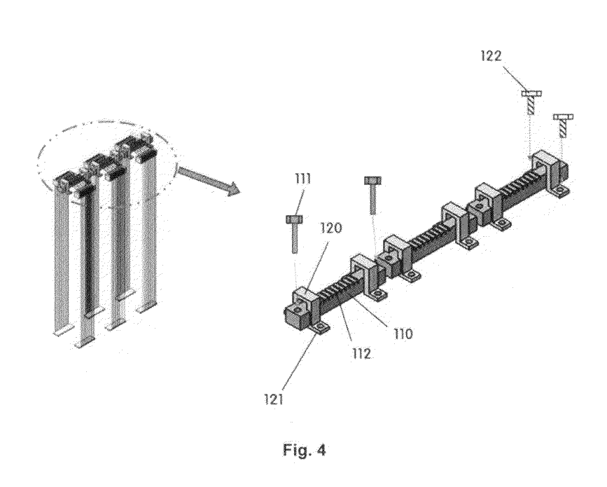

FIG. 2 is a schematic top view of a fuel cell stack assembly in accordance with a preferred embodiment of the present invention, FIG. 3 is a schematic bottom view thereof, and FIGS. 4 to 6 are detailed views thereof.

In a preferred embodiment of the present invention, as shown in FIGS. 2 and 3, a fuel cell stack is assembled by winding a plurality of wire 200 on a tensioner 110 and an upper guide 130, which are mounted on a portion of the top surface of an upper end plate 100, and inserting a locking member 160 into a lower guide 150 mounted on a portion of the bottom surface of a lower end plate 140, thus maintaining a constant surface pressure on a fuel cell.

More particularly, each of the two end portions of the wire 200 is connected to the locking member 160. A middle portion of the wire 200 is wound on the tensioner 110 and the upper guide 130. The locking member 160 is inserted into a locking groove 151 of the lower guide 150

Preferably, the wire 200 may be formed of a piano wire. The piano wire is generally formed of a spring steel material having a diameter of 0.1 to 5 mm. Also preferably, the piano wires may be twisted into a rope, if necessary.

Normally, the piano wire formed of a spring steel material and having a diameter of about 1 mm has a break load of about 1230 N and a tensile strength of about 151 MPa.

Moreover, if the wire 200 is made of a piano wire through a drawing process and the like, it can prevent defects such as impurities, pores and the like, which are associated with a fuel cell stack in which end plates are assembled by a bolt or band and have a strength close to the theoretical value, thus enabling the fuel cell stack to be lightweight and efficiently packaged.

In addition, when the wire 200 is formed of a super elastic alloy, the elasticity range may be increased 8 to 10 times compared with that formed of a spring steel. When it is formed of a shape memory alloy, it is possible to facilitate the wire compensation for a change in the surface pressure due to a thermal expansion at an operational temperature (about 80° C.) of the fuel cell.

In order to adjust the tension of the wire 200, as shown in FIG. 4, a plurality of tensioners 110 are mounted on a plurality of portions of the top surface of the upper end plate 100 by means of tension bolts 111. In this case, the vertical position of each of the tensioners 110 can be adjusted by the tension bolt 111 and thus the tension of the wire 200 can be adjusted according to the height of the tension bolt 111.

In particular, when the tensioner 110 is moved upward by rotating the tension bolt 111 in one direction, the tension of the wire 200 is increased, whereas, when the tensioner 110 is moved downward by rotating the tension bolt 111 in the opposite direction, the tension of the wire 200 is decreased, such that it is possible to maintain a constant surface pressure on the fuel cell by adjusting the height of the tensioner 110 according to the tensile state of the wire 200.

In this case, a plurality of guide grooves 112 are formed on a plurality of portions of the top surface of the tensioner 110 at regular intervals so that the wires 200 can be wound on the tensioner 110 without interfering with each other.

Preferably, it is possible to provide a ratchet wheel for winding the wire 200 instead of the tensioner 110 at the position where the tensioner 110 is mounted. In this case, the adjustment range for the wire length may be increased, and thus it is possible to fasten the wire 200 without a press during an initial connection of the wire 200.

Furthermore, a tension guide 120 having a central groove in shape of “π” is mounted on a portion of the top surface of the upper end plate 100 so as to surround the tensioner 110 at both ends of the tensioner 110, thus being able to guide the vertical (up and down) movement of the tensioner 110.

Each end of the tension guide 120 has a projection surface 121. The projection surface 121 is in contact with a portion of the top surface of the upper end plate 100. A bolt 122 is inserted into the projection surface 121 so as to fix the tension guide 120 to the upper end plate 100.

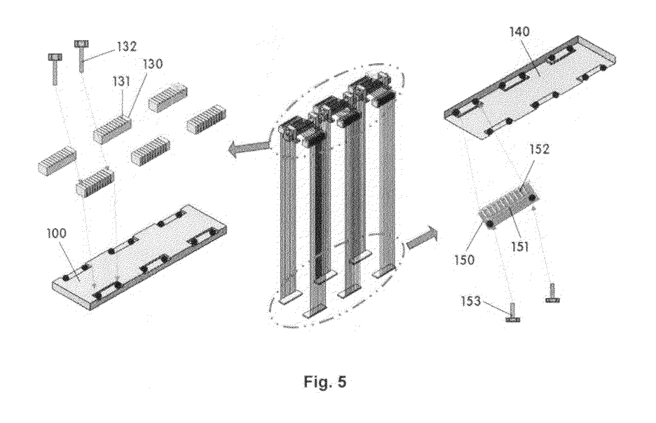

As shown in FIG. 5, a plurality of the upper guides 130 are mounted on a plurality of portions of the top surface of the upper end plate 100. Preferably, the upper guides 130 are positioned along side portions of the top surface at both sides of the tensioner 110 by means of bolt 132 so as to guide the wire 200 coming from both sides of the tensioner 110.

In this case, each of the upper guides 130 includes a plurality of guide grooves 131 formed thereon to prevent the wires 200 from interfering with each other. Suitably, the guide grooves 131 of the upper guide 130 may be formed with a curved surface to prevent stress from being concentrated on the wires 200.

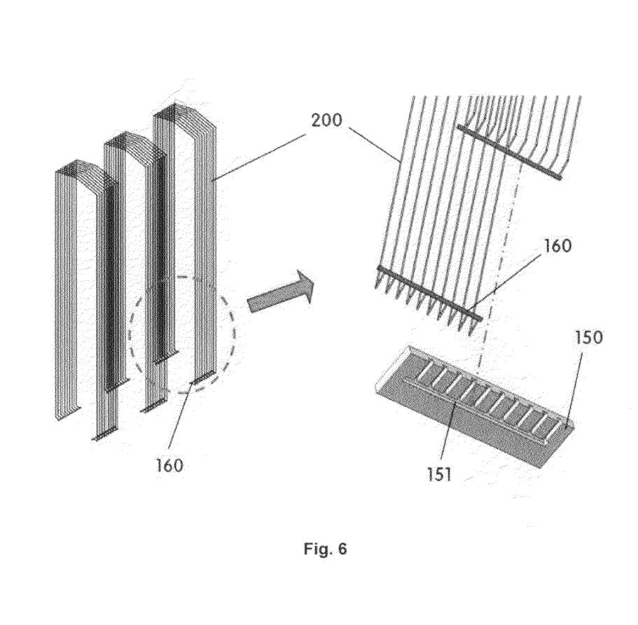

In addition, as shown in FIGS. 5 and 6, a plurality of the lower guides 150 are mounted on a plurality of portions of the bottom surface of the lower end plate 140 by means of bolts 153 so as to guide the wire 200 introduced to the lower end plate 140.

In this case, each of the lower guide 150 includes a plurality of guide grooves 152 formed at regular intervals the same as the guide grooves 131 of the upper guide 130. A locking groove 151 is formed on one side of the guide groove 152 of the lower guide 150 in the longitudinal direction thereof (i.e., perpendicular to the guide groove) so that the locking member 160 mounted on the end of the wire 200 is inserted therein.

That is, the locking members 160 mounted on both ends of the wires 200 are inserted into the locking grooves 151 provided on both sides of the lower end plate 140 such that the wire 200 maintains the tightness at a constant tension and the tension is adjusted according to the height of the tensioner 110 on which the wire 200 is wound.

Preferably, the locking member 160 may be formed of a cylindrical metal material so that the plurality of wires 200 are connected at regular intervals.

As described above, the fuel cell stack assemblies in accordance with the preferred embodiments of the present invention provide advantages including the following: 1) since the fuel cell stack is assembled by means of the wire, it is possible to maintain a constant surface pressure on the fuel cell by utilizing a wide elasticity range of the wire; 2) even with a small amount of material, it is possible to ensure a high fastening force, thus making the fuel cell lightweight and maximizing the package efficiency; and 3) with the up and down movement of the tensioner, it is possible to adjust the tension of the wires to control the surface pressure on the fuel cell and easily measure the tension associated directly with the surface pressure on the fuel cell.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A fuel cell stack assembly for a fuel cell, comprising:
at least one wire for fastening end plates mounted on both end portions of a fuel cell stack;
at least one tensioner mounted on at least one portion of the top surface of an upper end plate;
at least one tension guide each of which includes a central guide for guiding up and down movement of the tensioner and surrounds the tensioner;
at least one upper guide mounted on both sides of the top surface of the upper end plate for guiding the wire; and
at least one lower guide mounted on both sides of the bottom surface of a lower end plate for guiding the wire.

2. The fuel cell stack assembly of claim 1, wherein the tensioner is mounted on the top surface of the upper end plate by means of a tension bolt such that the height of the tensioner is adjusted by the tension bolt, thereby the tension of the wire being able to be adjusted.

3. The fuel cell stack assembly of claim 1, wherein each of the tensioner, the upper guide and the lower guide includes a plurality of guide grooves such that the wires received in the guide grooves do not interfere with each other.

4. The fuel cell stack assembly of claim 3, wherein the lower guide includes a locking groove formed therein in a direction perpendicular to the guide grooves of the lower guide, and both ends of the wire have a locking member mounted thereon to be inserted into the locking groove of the lower guide.

5. The fuel cell stack assembly of claim 1, wherein the wire is formed of a piano wire or a shape memory alloy.
